(19) United States
(12) Patent Application Publication
(10) Pub. No.: US 2010/0082367 A1
(43) Pub. Date: Apr. 1, 2010

(54) SYSTEM AND METHOD FOR PROVIDING A HEALTH MANAGEMENT PROGRAM

(76) Inventors: Burdette (Ted) Harmon Hains, Toronto (CA); John (Jay) W. Whiteside, Toronto (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/568,874

(22) Filed: Sep. 29, 2009

Related U.S. Application Data
(60) Provisional application No. 61/101,816, filed on Oct. 1, 2008.

(51) Int. Cl. G06Q 50/00

(52) U.S. Cl. 705/2

(57) ABSTRACT

There is provided a system and method utilizing an integrated communications platform that in one embodiment, provides a pharmacist-assisted medication therapy management program involving a behavioural targeting algorithm to personalize mobile messages designed to increase medication adherence and to improve health outcomes among patients living with chronic disease. The integrated communications platform provides a mobile messaging platform that sends scheduled reminders to persons living with such chronic diseases to take their medication. In this way, the messages can be received anywhere and at any time to improve the link between the patient and the system. The algorithm uses scientific measurement tools to segment beliefs by disease type and stage and through the distribution of the system by medical professionals such as pharmacists provides a unique point of customer contact to allow pharmacists to engage patients and improve medication adherence and overall health.

This application claims priority from U.S. Provisional Application No. 61/101,816 filed on Oct. 1, 2008, the contents of which are incorporated herein by reference.

### FIELD OF THE INVENTION

The invention relates to systems and methods for providing health management programs.

### BACKGROUND

It is well established that there can be considerable disruptive effects on the quality of care of an individual because of non-adherence with health and medical advice, for example, non-adherence to a medication schedule (Becker M H, Maiman L A; “Sociobehavioral Determinations of Compliance with Health and Special Medical Care Recommendations”; Med Care 1975 January; 13(1):10-24). Patient compliance is paramount in the effectiveness of therapeutic regimens. Without compliance, therapeutic goals cannot be achieved, resulting in poorer patient outcomes. The social and psychological factors thought to influence compliance are identified as (a) knowledge and understanding communication, (b) quality of the interaction including the patient-provider relationship and patient satisfaction, (c) social isolation and social support including the effect of the family, and (d) health beliefs and attitudes (Catherine Cameron RGN OncCert MSc; “Patient Compliance: Recognition of Factors Involved and Suggestions for Promoting Compliance with Therapeutic Regimens”; Journal of Advanced Nursing: Vol. 24 Issue 2 Page 244, August 1996).

One problem with adherence to health and medical advice is that individuals, for the most part, need to implement a routine or practice of self-management. Support of patient self-management is an important component of effective chronic illness care and improved patient outcomes (Coleman, Mary T. and Newton, Karen S.; “Supporting Self-Management in Patients with Chronic Illness”; Am Fam Physician, 2005 Oct. 15; 72(8): 1503-10).

It has been stated by the WHO in 2003 that “Increasing the effectiveness of adherence interventions may have a far greater impact on the health of the population than any improvement in specific medical treatments”. Non-adherence can be affected by both asymptomatic factors (e.g. I don't feel any symptoms) and symptomatic factors (e.g. denial, rebellion). Lifestyle also plays a role in non-adherence through forgetfulness, being too busy and otherwise not being able to fit in the health management process into their lifestyle. Accordingly, patients often feel a lack of motivation and lack of reinforcement can only exacerbate this situation.

To deal with self-management, reminders have traditionally been used, ranging in complexity from manually entered calendar reminders and manually filled pill organizers to electronic reminder systems. Electronic reminders have been available for many years and some examples include vibrating watch alarms, electronic pill organizers, pagers, pillbox timers, automatic pill dispensers, medical alarm clocks, multi-alarm timers, countdown timers, medical jewellery, pill identification tablets, key chains etc. These devices are based on the assumption that a simple, passive “reminder” is an effective long-term approach to improved adherence. However, it has been found that such approaches are typically not sustainable as the reminders often become considered a nuisance, boring or simply high-tech “nagging”. Moreover, such reminders also lack the necessary components for effective and sustainable self-management, which can vary from individual to individual.

One alternative to the aforementioned reminders is a specialized wireless electronic bottle cap that replaces standard pill container caps and monitors patient activity by detecting when the bottle is opened and closed. Another alternative is to utilize automated outbound calling to residential phones, which use interactive voice response (IVR) speech recognition software to simulate one-on-one consultations. In other cases, similar strategies are achieved through postal mail.

Yet another alternative is to use an electronic monitor and related health management programs. However, these are typically expensive, tend not to be portable, often cannot scale for widespread use, lack personalization and may employ unfamiliar technologies. One example is the Health Buddy® system offered by Health Hero®, described for example in U.S. Pat. No. 5,960,403. The Health Buddy system uses evidence-based practice guidelines for interactive patient education for persons living with a chronic illness, through daily multiple choice question sequencing. The Health Buddy device can attach to other electronic reminder devices. However, requiring the use of another electronic device can be prohibitive due to cost and can also be both cumbersome and ‘fixed’ for many individuals.

There is thus a need for a health management system that addresses the problems described above.

### SUMMARY

In one aspect, there is provided a method for providing a wellness management program for a user comprising: obtaining information pertaining to the user, the information providing an indication of behaviours, attitudes and demographic data for the user; associating a wellness professional with the user; assigning the user to one of a plurality of clusters, each cluster defining a user group with similar behaviours and attitudes toward the wellness management program; obtaining content according to the one cluster assigned to the user, the content being related to the wellness management program; sending messages to the user using the content according to a schedule; and enabling a communication link between the user and the wellness professional.

In another aspect, there is provided a computer readable medium comprising computer readable instructions for performing the method.

In yet another aspect, there is provided a wellness management system for providing a wellness management program for a user comprising: a first interface for obtaining information pertaining to the user, the information providing an indication of behaviours, attitudes and demographic data for the user; a management engine for associating a wellness professional with the user, for assigning the user to one of a plurality of clusters, each cluster defining a user group with similar behaviours and attitudes toward the wellness management program, for obtaining content according to the one cluster assigned to the user, the content being related to the wellness management program; a second interface to a communications service for sending messages to the user using the content according to a schedule; and a communication link between the user and the wellness professional.

In one exemplary embodiment, these aspects are applied to a health management program linking a patient to a pharmacist for promoting adherence to the health management program.

### BRIEF DESCRIPTION OF THE DRAWINGS

An embodiment of the invention will now be described by way of example only with reference to the appended drawings wherein:

FIG. 1 is block diagram illustrating a health management system connecting a patient, pharmacist and physician.

FIG. 2 is a schematic diagram illustrating the interaction between elements for promoting adherence through the health management system.

FIG. 3 is a diagram illustrating information used to establish health clusters used by a behavioural targeting algorithm.

FIG. 4 is a flow diagram illustrating the feedback data utilized in creating and updating the clusters.

FIG. 5 is a block diagram showing further detail of the health management system shown in FIG. 1.

FIG. 6 is a flow diagram illustrating various interactions between the health management system and various individuals.

FIGS. 7 to 9 are a series of flow diagrams illustrating an example data flow using the health management system.

FIG. 10 is a block diagram illustrating various functional modules associated with the pharmacist portal, patient portal and patient devices shown in FIG. 2.

FIG. 11 is a block diagram illustrating various functional modules associated with the health management engine, support portal, health quotient (HQ) algorithm system and content management portal shown in FIG. 5.

FIG. 12 is a block diagram illustrating various functional modules associated with the campaign management component shown in FIG. 5 and various functional modules associated with a message delivery component and a quote to completion component.

FIG. 13 is a flow diagram illustrating the computation of an HQ score used to determine cluster-specific messages.

FIG. 14 is a chart comparing attitudes and knowledge in self-management.

FIG. 15 is a flow diagram illustrating a general framework for promoting adherence to any wellness program.

FIG. 16 is a flow diagram illustrating the application of the framework of FIG. 15 to include family or caregiver support.

### DETAILED DESCRIPTION OF THE DRAWINGS

It has been recognized that in order to improve adherence to a health management program, generic, impersonal reminders should be replaced with a personalized system that provides support to a patient and considers the patient's behaviours, attitudes and support system in addition to traditional metrics such as demographics. It has also been recognized that such a support system can be strengthened by incorporating an authoritative link between the patient and trusted medical professionals, in particular the pharmacist. This can also be applied to other application to promote adherence to any regimen or wellness program that benefits from the framework and principles described below.

For example, it has been found that personalization of a health management system can be achieved by employing behavioural clusters rather than generic reminders or impersonal demographic-based information. The personalization of the health management system then provides a way to maintain interest for a patient thus increasing the likelihood of adherence. This, in combination with the enhanced support system and link to a trusted medical professional, encourages the patient to embrace adherence to a health management program such as taking medication, exercising, healthy eating habits, etc.

Moreover, according to the World Health Organization (WHO) best practices: “the time is ripe for large-scale, multi-disciplinary field structures aimed at testing behaviourally sound multi-focal interventions, across diseases and in different service delivery environments”. The need for improving adherence is therefore paramount.

Described below is an integrated communications platform that provides a pharmacist (or other medical professional) assisted medication therapy management program involving a behavioural targeting algorithm to personalize mobile messages designed to increase medication adherence and to improve health outcomes among patients living with chronic disease.

The integrated communications platform can provide a mobile messaging platform that sends scheduled reminders to persons living with such chronic diseases to take their medication. The reminders may be delivered to the patients via any mobile messaging medium, e.g. text messages, email etc. In this way, the messages can be received anywhere and at any time to improve the link between the patient and the system. The reminders can be presented in a personalized information message that is specific to a particular disease and may include tips to promote adherence and self-management. The supporting communications platform may include a personalized web page for each patient that includes a compendium of messages along with more detailed information and peer support for their disease. As noted above, a behavioural targeting algorithm is used to identify segments of patients according to their health beliefs and attitudes. The algorithm uses scientific measurement tools to segment beliefs by disease type and stage and generate a health quotient (HQ) for the patient. It has been found that the distribution of the system through medical professionals such as pharmacists can provide a unique point of customer contact and allow pharmacists to engage patients and improve medication adherence and overall health.

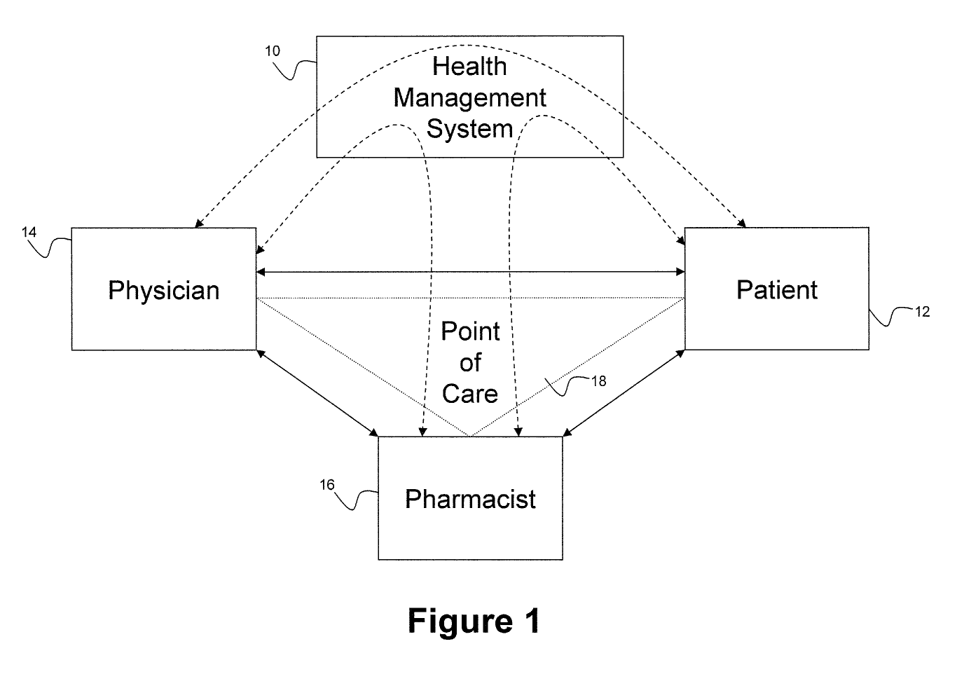

Turning now to FIG. 1, a point of care triangle 18 showing the interactions between a patient 12 and their physician 14 and pharmacist 16 is illustrated, and a health management system 10 (hereinafter the “system 10”), which provides the communications capabilities and technology to realize a tangible application of the point of care triangle 18. It can be seen in FIG. 1 that the system 10 enables interactions between the patient 12 and the physician 14, the patient 12 and the pharmacist 16 as well as between the pharmacist 16 and the physician 14. Through this configuration, management of the patient's condition and the progress and statistics associated with treatment thereof can be implemented, tracked and refined. It will be appreciated that in other configurations, the patient 12 may communicate indirectly with the physician 14 through the pharmacist 16 and vice versa. Therefore, the interactions shown in FIG. 1 are illustrative only and may be changed to suit a particular application.

The patient 12 can be introduced to and enrolled with the system 10 in various ways. In one embodiment, the pharmacist 16 identifies the patient 12 through the normal pharmacist-patient relationship and encourages enrolment. The system 10 can be used to facilitate management of the condition and the pharmacist 16 can provide a description of what will be received, the schedule and merits of using the system 10, how to enrol and obtain permission to opt-in or a decision to opt-out. By incorporating the pharmacist 16 into the system 10, a unique point of contact can be harnessed to provide a reliable and trustworthy link during initiation of the patient 12 into a health management program, e.g. a drug regimen. In other embodiments, the patient 12 may be introduced to the system 10 in other ways such as through the physician 14, through community or social connections, through online searching, browsing of a website provided by the system 10 and various other methods, e.g. direct mail.

The pharmacist 16 is also incorporated into the system 10 to communicate with the patient 12 and actively involve the patient 12 to provide knowledge and understanding and support. Such knowledge and understanding may relate to current health status, diet, exercise, drug therapy regimens, treatment plans, target goals, responsibilities, opportunities to improve outcomes, nature of adverse outcomes and how the system 10 can complement an overall wellness program. The pharmacist 16 can also communicate with the physician 14 to provide objective results, progress notes, evaluation of patient therapy and needs and assist in planning for optimizing the therapy. It will be appreciated that such communications can be facilitated through the system 10 directly, e.g. via messages, downloads/uploads or indirectly, e.g. via information posts to a common patient profile. In this way, the physician 14 can benefit from having more complete and ongoing information related to a patient 12 that can not necessarily be achieved through clinic visits, office check-ups etc.

By providing the linkages shown in FIG. 1, the system 10 facilitates the patient's understanding in the risk factors, treatment plan, target goals and progress associated with their condition, thus engaging the patient 12 at a more personalized level that merely providing routine reminders at scheduled intervals.

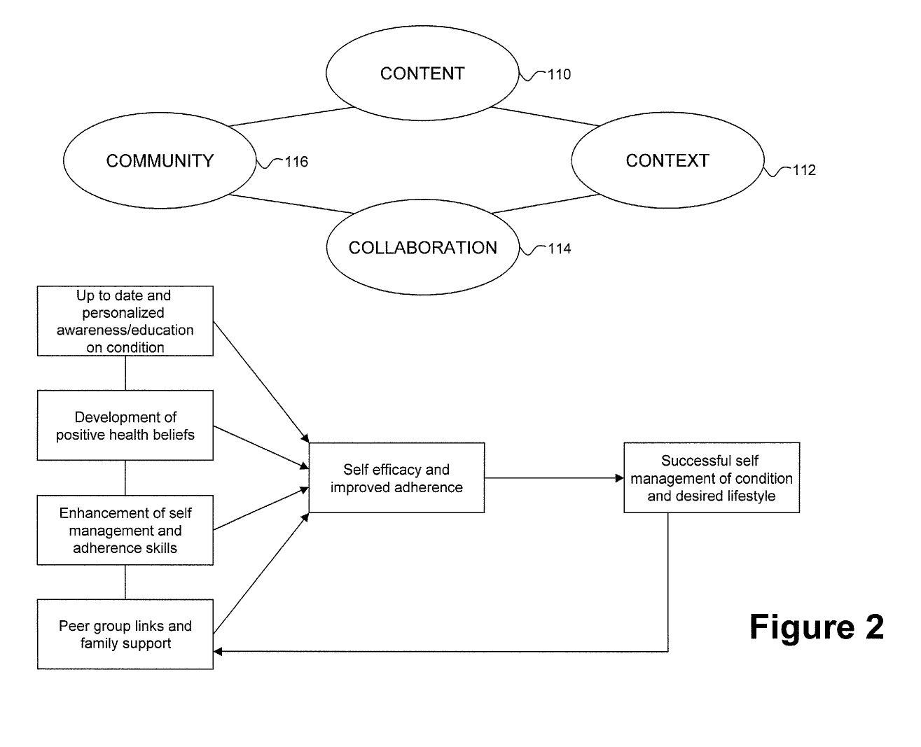

Turning now to FIG. 2, four interacting elements are shown, which are considered important in developing an HQ for a patient 12. Considering content 110 enables the system 10 to tailor the messages and the program to individual interests and lifestyles, which makes the content more meaningful, desirable and valuable to the patient 12. Considering context 112 enables the system to ensure that content 110 is directly relevant to usage occasions by linking messages to lifestyles; which are personal, friendly and discreet while being delivered to the patient 12 anywhere at any time. Collaboration 114 involves building trust with the patient 12 over many interactions. It has been recognized that adherence is more common where the patient 12 believes that the relationship is meaningful. As discussed above, inclusion of the pharmacist 16 and making them directly involved facilitates this. A community is therefore established within the system 10 that delivers timely, proactive messages 86 with easy ways to interact and inform one another.

Also shown in FIG. 2 is a blueprint illustrating a strategy taking into consideration the interacting elements 110-116. Self efficacy and improved adherence can be achieved through up to date and personalized awareness/education on the patient's condition, through a development of positive health beliefs, through enhancement of self-management and adherence skills and through peer group links and family support. Through self efficacy and improved adherence, the patient can experience successful self-management of their condition and desired lifestyle. The system 10 which will be discussed in greater detail below, is configured according to such a blueprint.

By considering these elements when creating content and clustering patients 12, adherence can be strengthened. Successfully adopting and continuing with a long term medication regimen requires behaviour change and behaviour change principles can be used to accelerate the adoption of adherence to medication-taking behaviour. The efficacy of behaviour changing interventions, which are tailored to each patient's stage of change, has been demonstrated in several health behaviour areas. Rewards, monitoring devices and reminder techniques are most useful for individuals in later stages of behaviour change, but individuals in early stages need consciousness-raising interventions that focus upon awareness of the benefits of therapy (Willey, Cynthia, PhD; “Behavior-changing Methods for Improving Adherence to Medication”; Current Hypertension Reports; 1999; 1: 477-481; Current Science Inc.). Accordingly, the system 10 has been configured to provide more awareness and more personalized content and reminders to promote behaviour change rather than routine “nagging”.

Non-adherence to drug regimens can be due to many factors such as: forgetfulness, no symptoms or symptoms have gone away, desire to save money, not having health insurance, distrust in the effectiveness of a drug, distrust in the reasons for even needing the medication, side effects, apprehension, impact on other activities (e.g. alcohol consumption), lack of reminders, inability to fill a prescription, religious reasons, cultural reasons, lack of information or understanding of the severity of a disease and physical dependency on others.

An HQ behavioural clustering algorithm has been created (as will be explained in greater detail below) that is configured to collect, integrate and analyze a patient's physical conditions, attitudes, healthcare behaviour, lifestyle, cultural affiliations, social affiliations, religious affiliations, demographics, geographic data and other factors, to provide improved patient insight for encouraging the patient's drug adherence. The HQ algorithm is relied upon to develop a targeted message system that goes beyond traditional generic interventions, e.g. electronic reminders that fail to address important drivers of a patient's behaviour. Among individuals with chronic problems, the system 10 identifies clusters with similar attitudes, behaviours and lifestyles that enable the system 10 to predict patient behaviour on drug adherence and communicate with them more effectively for better management of their diseases.

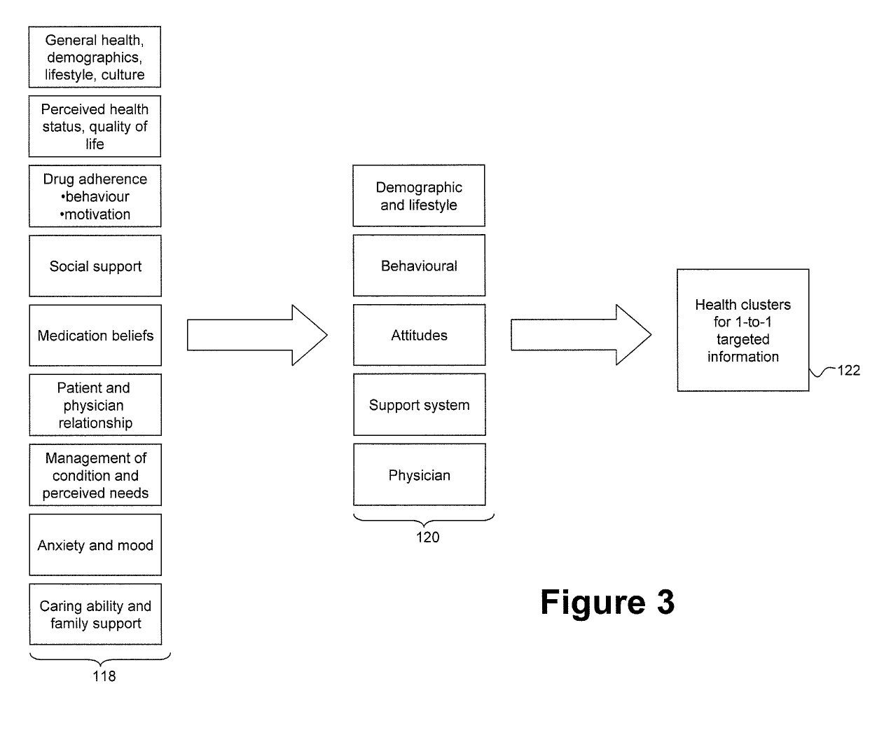

Turning now to FIG. 3, in order to segment patients for the purpose of providing individualized health management programs, it has been found that various themes 118 should be considered. FIG. 3 illustrates nine themes 118, namely: general health, demographics, lifestyle and culture; perceived health status, quality of life; drug adherence, both behaviour and motivation; social support; medication beliefs; patient and physician relationship; management of condition and perceived needs; anxiety and mood; and caring ability and family support. It will be appreciated that each theme may be supported by many sub-themes. Of the themes 118, several groupings 120 are identified, namely demographic and lifestyle, behavioural, attitude, support system and physician. The groupings 120 are evaluated to develop the health clusters 122, which are used to provide 1-to-1 targeted information that is relevant to the patients 12. The system 10 can determine how a patient 12 fits into the groupings using surveys and questionnaires, delivered to them as discussed above. For example, a survey with a number of questions may be presented to the patient 12 at the time of registering with the system 10. The cluster analysis may then be performed once many patients 12 are registered, i.e. once there is a sufficient base of respondents to create the clusters 122. It will be appreciated that the clusters 122 may instead be predefined and the groupings identified from the clusters 122 and patients 12 grouped according to a best fit based on how they respond to questions associated with the groupings.

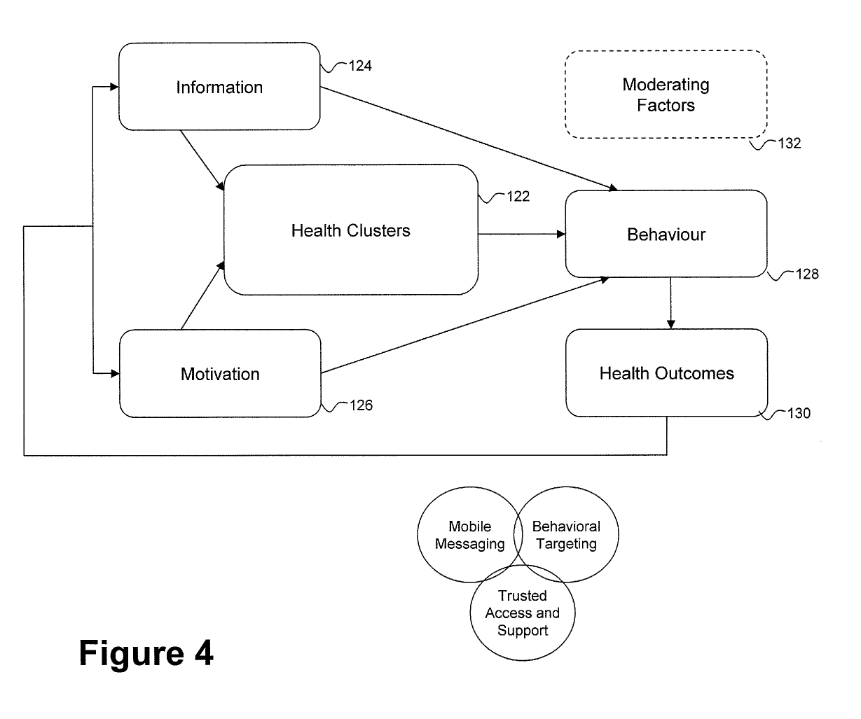

FIG. 4 illustrates the inputs, outputs and feedback that may be considered when developing an HQ algorithm for clustering patients 12. In this example, the health clusters 122 are generated according to information 124 and perceived motivations 126. The health clusters 122, and the associated content delivered to the patients 12, should induce changes in behaviour 128, which then translates into health outcomes 130, which may then be used to modify, augment, refine or change the information 124 and motivations 126 behind the grouping of the clusters 122. Also shown in FIG. 4 is a set of moderating factors 132 that, in general, affect the HQ algorithm. The information 124 can include regimen data and what constitutes adequate adherence, as well as side effects and beliefs in the medication as perceived by the patient 12. The motivations 126 may comprise personal attitudes and beliefs about the outcomes of adherent and non-adherent behaviour (i.e. consequences of a health program), as well as social motivations such as perceptions of support and motivation to comply with significant others' wishes. Motivations 126 can also be dictated by beliefs in medications.

The health clusters 122 are developed according to objectives and perceived abilities (self-efficacy). The clusters 122 strive to tailor a program such that the patient 12 can incorporate a regimen into daily life, minimize side effects, receive knowledge updates about their condition, provide the proper social support and to promote self-reinforcement. The behaviours 128 or conditions that are desired is facilitated by knowledge and proper dosing, adherence levels over time and change/adaptation of lifestyle. The health outcomes 130 can be adherence, objective health status, health care utilization, personal and family satisfaction and HQ tracking. The moderating factors 132 that can affect this process are psychological health, living situation, access to medical care and services (e.g. insurance coverage) and family support (i.e. zone of influence).

It can be seen from FIGS. 3 and 4 that in order to tailor content such that it is meaningful to the patient 12 and promotes self-management and ultimately adherence to a health management program such as a drug regimen, various factors should be considered and behaviours can dictate how certain patients 12 are classified and how such content is selected. As can be seen in FIG. 4, the use of mobile messaging, behavioural targeting and trusted access and support from the pharmacist 16 facilitates adherence to the health management program and as will be explained below can be achieved using the system 10. It will be appreciated that FIGS. 3 and 4 illustrate only one example and various other methods may be employed to classify and assign patients 12, content and the way in which content is delivered to the patient 12.

As discussed above, in order to develop clusters 122 and ultimately assign a patient 12 to a particular cluster code, information regarding the patient 12 should be gathered, preferably at the time the patient 12 enrols with the system 10. FIGS. 3 and 4 illustrate that the system 10 is configured to look beyond demographic information to personalize message content, in particular according to disease type and state and according to the behaviours, attitudes and support system of the patient 12. One way to obtain such information is to display for the patient 12, a survey. Mechanisms for providing and obtaining results for such surveys will be explained below. The following provides an example survey wherein the patient 12 is asked to answer each statement according to a scale of 1 to 5, from “Strongly disagree” (1) to “Strongly agree” (5):

1. I am actively managing my health/I think of disease as an enemy to be conquered

2. I don't like doing things according to a schedule like taking medications

3. I prefer to not take any pills

4. My health could probably improve if I used my medications as prescribed

5. I think there is something seriously wrong with my health

6. I have no idea for the reason of my symptoms

7. Left untreated, the sickness will eventually go away

8. My sickness may be triggered by strong emotions

9. I ask my doctor for advice about my health

10. My condition will improve if I ask for the help of a specialist

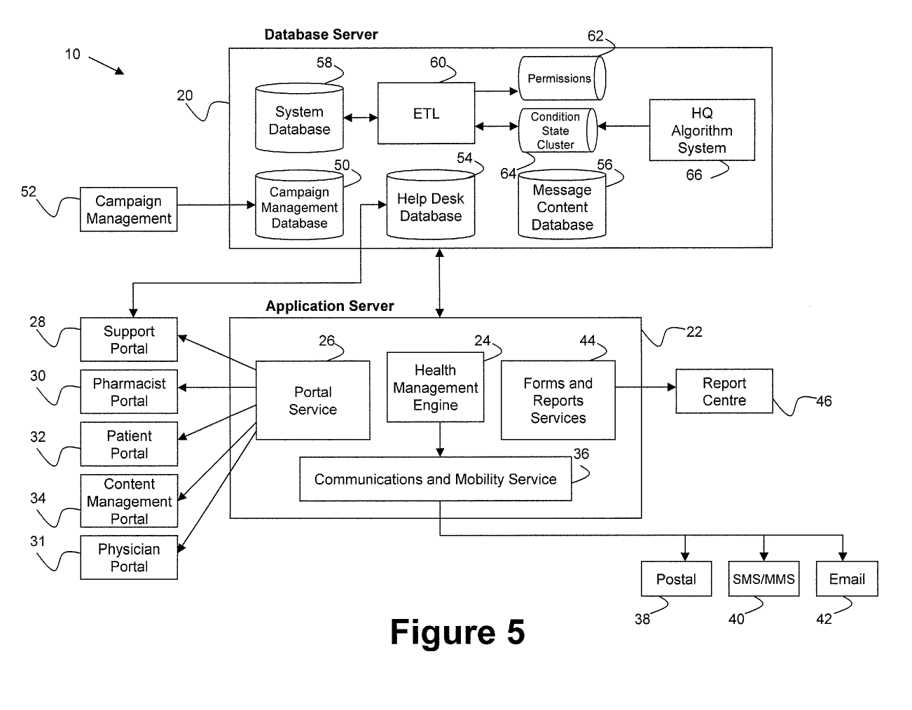

The above statements are illustrative of one way to encourage behaviour-based responses, which can be used to identify how a patient 12 deals with their disease and the incorporation of a drug regimen into their lives. Based on the survey data, an HQ algorithm system 66 (see also FIG. 5 described below) can perform a segmentation analysis to identify clusters 122 of patients 12 with similar attitudes and behaviours towards healthcare so that each group of patients 12 associated with that cluster 122 can be communicated with targeted messages to improve their drug adherence. For example, the following clusters can be identified from survey responses:

A: Sceptical

B: Resigned

C: Confused

D: Concerned

E: Confident

F: Proactive

It may be appreciated that clusters A and B would be expected to have poorer adherence than cluster F and thus would naturally require different content and communications from those in cluster F.

The objective of a segmentation analysis is to derive a structure among all patients and to understand their behaviours and attitudes. Furthermore, the segmentation analysis should help to predict a patient's HQ and in turn his/her behaviour on drug adherence. Using the system 10 described above, the patients 12 may then be given targeted communications encouraging improvement of drug adherence. As discussed above, the patient 12 is engaged by the pharmacist 16 and targeted with personalized content and provided with an interface to the system 10 in order to educate and incorporate them into their health management program.

A segmentation analysis is a process which clusters patients with distinct attributes into appropriate groups so that patients in the same group are “very” similar (i.e. to achieve homogeneity) and so that patients in different groups are “much” different (i.e. having heterogeneity between groups).

The measures for similarity should be considered in order to properly define the groups. In particular, for category variables, there are many ways to define a similarity matrix. For example, latent semantic index techniques can be used to associate keywords and information that form clusters. For interval scale variables, Euclid or Mahalanobis distance may be used.

In order to achieve the above, the health management system 10 is designed to provide an underlying architecture to enrol patients 12, cluster patients 12 and deliver content to the patients 12. FIG. 5 illustrates one configuration for implementing the system 10. In the configuration shown in FIG. 5, a database server 20 and an application server 22 are utilized. The application server 22 incorporates a computer-based health management engine 24 that manages the operations of the system 10, a portal service 26 to provide various interfaces to the various individuals utilizing the system 10, a forms and reports service 44 for interfacing with a report centre 46 to enable the system 10 to provide reports and other data to individuals as part of monitoring and refining the health management program, and a communications and mobility service 36 to deliver content such as reminder messages and other information through various media, e.g. postal 38, SMS/MMS 40 and email 42 among others.

The portal service 26 enables custom portals to be designed and launched for specific individuals. FIG. 2 illustrates the incorporation of a support portal 28 to provide support to the system 10, a pharmacist portal 30 tailored to the pharmacist 16, a patient portal 32 tailored to individual patients 12, a physician portal 31 tailored to physicians 14 and a content management portal 34 to enable the provision and refinement of content to be provided to the various individuals.

The database server 20 provides various data storage and data management modules and components to store, transport, receive, manage, search, edit, delete, archive etc. any and all data and information used and provided by the system 10. As such, it will be appreciated that the configuration of the database server 20 shown in FIG. 5 is shown only for ease of explanation and that any database structure can be used. For example, one master database could be used to perform the functional roles exemplified in FIG. 5. A campaign management database 50 is shown, which handles data associated with running a campaign provided by a campaign management module 52. In the following, a “campaign” will refer to any plan, regimen, study, service or structure that provides a health management program for one or more patients 12. A help desk database 54 is also shown, which provides supporting information that can be used by the support portal 28 in providing assistance, answering queries etc. A message content database 56 is also provided for storing and organizing all message content. A system database 58 is also provided, which stores information related to the individuals enrolled with the system 10, e.g. patients 12, pharmacists 16, sponsors etc. The database server 20 may utilize an extract-transform-load (ETL) function 60 for managing data of different formats. A permissions database 62 can be maintained that comprises IT related permissions associated with users of the system 10, e.g. who has opted in or opted out, permissible forms of communication etc. A condition state cluster module 64 is used to store cluster codes for each patient 12. A health quotient (HQ) algorithm system 66, which scores a patient's condition state, e.g. to quantify the progression of a disease stores the cluster codes for each patient 12 in the cluster module 64. Further detail of the cluster codes, HQ and algorithm system 66 will be discussed later.

The campaign management module 52 provides an interface to enable the capture of campaign data, which can then be used by the HQ algorithm system 66 for determining clusters for patients 12 and used in conducting content management. A campaign can be a short-term or long term study or an ongoing process for enrolled patients 12.

The support portal 28 enables a care representative to provide support to the health management system 10 in part by having access to the help desk database 54. The support portal 28 can interface with a website to gather support-related emails and, if equipped, phone calls. The support portal 28 is configured to log support cases and to prepare activity reports on a periodic basis such as weekly and should support queries from both patients 12 and pharmacists 16. In one embodiment, the support portal 28 establishes a customer relationship management (CRM) link between the system 10 and the patient 12 to minimize participation attrition and to maintain the trusted link. For the pharmacist 16, the support portal 28 should facilitate the gathering of requested information and to assist in problem solving to ease the burden of the pharmacist 16 in recruiting patients 12. The support portal 28 also provides a source of feedback for the system 10 to refine the content, delivery methods and programs. The support portal 28 in this embodiment should also provide answers to FAQs, provide a help desk like interface, provide a phone number, provide an email address, provide a website to enable self-support and, if appropriate, a service level agreement (SLA) for response time and an SLA for problem resolution.

The pharmacist portal 30 is designed to collect registration details from the pharmacist 16 and provide information that is of interest to the pharmacist 16. The pharmacist portal 30 is configured to enable the pharmacist 16 to input pharmacy and pharmacist-in-charge contact data (including email) and, once registered, the pharmacist 16 can review and download on-line training documentation to support the recruitment of patients 12 to the system 10. The pharmacist portal 30 should be designed to limit data entry and keep the number of key strokes and other inputs to a minimum to respect of the pharmacist's time constraints and thus encourage further recruitment efforts by the pharmacist 16. The pharmacist portal 30 can also provide a way to order training materials and patient handouts.

The patient portal 32 should be designed to encourage prolonged and frequent usage by the patient 12 in order to strengthen compliance and the dissemination of knowledge to the patients 12. The patient portal 32 is designed to collect patient enrolment details, host surveys, manage user preferences and display a personalized webpage for the patient 12 that, if appropriate, also incorporates sponsor/advertising/marketing content. The patient 12 can be prompted to enter contact information along with drug dosage and regimen details and be able to select a pharmacist code from a list which will populate the pharmacist details for the patient profile. During the enrolment process, the patient 12 is presented with a questionnaire, prompted to select their lifestyle preferences and preference for refill reminders (cell and/or email). Those patients 12 with email through a cell phone can be presented with the option to receive daily reminders via email.

The physician portal 31 can be provided if the physician 14 is to participate in the exchange or posting of information for the patient 12 through the system 10.

To control the enrolment process, the patient 12 may be required to “sign” a waiver to complete an initial opt-in process. Once the waiver is signed off the enrollment is done, the data captured from the questionnaire can be sent to the HQ Algorithm system 66, where the patient 12 is assigned a cluster code, a secure login web page is generated and the patient 12 is flagged as “pending” until a second opt-in, i.e. thus implementing a double opt-in process. This may be done to ensure the identity of the patient 12 for privacy and other concerns. At any point after the double opt in, the patient 12 can go to the patient portal 32 and view their message history, update their reminder schedule and update their lifestyle preferences etc. The patient should be given the opportunity to opt-out of the system 10 which may then trigger a short exit survey to support program analysis.

The patient's website should be available 24/7 and provide a low technical failure rate. For example, the patient 12 should be able to sign-up and log-in through a main website provided by the system 10 at any time and email connectivity should remain reliable to reduce patient drop off resulting from frustration with the patient portal 32. The patient portal 32 should also act immediately upon sensing a patient opt-out, e.g. cell phone messaging should be suspended once the patient 12 opts out of their program. In order to measure pharmacist engagement, the patient portal 32 can trace the patient 12 back to the pharmacist 16 that introduces the system 10 by associating the pharmacist 16 with the patient 12 during enrolment. Traceability back to the pharmacist will provide value when measuring pharmacist engagement.

Patient information and disease state can be captured when the patient 12 registers for the program through the patient portal 32. The following information may be requested: name, address, mobile phone number, home phone number, email address, pharmacy, drug name(s), dosage and regimen, refills indicated, etc. More detailed questions may be asked such as: “Is this a newly diagnosed condition and the first prescription or is this a condition that has been treated with medication for more than six months?”. Also, a unique identifier code may then be established, which allows the system 10 to track patient behaviour at the pharmacy and measure refills.

As noted above, the patient portal 32 also provides an interface to acquire survey information from the patient 12. Various surveys can be constructed and provided for various reasons such as to gauge satisfaction and behaviour levels at the beginning and adherence related surveys during the program to track patient progress and usage. Other methods can be used to obtain feedback and track progress such as by providing a mobile diary which allows a patient 12 to records events, changes, missed medication etc. The surveys are most conveniently conducted via email, website entry forms or via mobile devices, however, phone and postal surveys can also be incorporated.

To speed up the patient enrolment process, the patient portal 32 can utilize any suitable user-interface mechanism such as drop-down menus and searchable databases listings for pharmacists 16 and any other information that can be presented to the patient 12 for selection rather than manual entry. The patient 12 is also able to personalize their webpage provided through the patient portal 32 by being provided various choices to customize their experience. For example, the patient 12 can be presented with a menu of lifestyle content choices, examples of which may include without limitation, sports, weather, jokes, entertainment. This allows the system 10 to provide additional information that is of interest to the patient 12 that can be provided with the health-related content and can also enable the system 10 to provide value added items such as coupons. To further enhance the patient's experience, the patient portal 32 can also be configured to request that the patient 12 select which medium/media to use for sending refill and consumption reminders. For example, the patient 12 may have the choice of receiving reminders via mobile device only (SMS, MMS, email etc), web-based email only (e.g. Outlook®, Gmail™ etc.), or both. The patient portal 32 also provides web-based access for the patient 12, which can facilitate ongoing updates to be made to the patient's profile, e.g. drug class, schedule changes, etc. This allows the system 10 to constantly adapt to the patient's changing needs.

The patient portal 32 also provides a window into the behaviour profile of the patient 12 through their associated portal activity. This allows the system 10 to measure or rate the interactions associated with the patient 12. Similarly, patient medication script renewals can also be tracked by the system 10 through the patient portal 32. In this way, a measure of patient adherence can be determined from script renewal on an ongoing basis. The patient 12 can also be requested to self report at interval survey gathering times, however it is noted that tracking script data can be more accurate.

The system 10 is thus configured to improve medication and advance patient care, thus enhancing patient-pharmacist relationships and providing a unique stage for targeted marketing. This is a win-win-win solution for patients 12, pharmacists 16 and those companies and organizations who benefit from marketing, increased sales and reduced health care expenses associated with non-adherence.

The content management portal 34 provides an interface to support the design, development and approval of message content. A secure login can be used to restrict access, and designated persons, with access, can create or modify the message content and define usage parameters. The content management portal 34 can be used by any appropriate personnel, such as a content creator, an approver of content, and an administrator for publishing the final product. The content created should be correlated to a cluster code generated by the HQ algorithm system 66 so that it may be linked to the appropriate group of patients 12. The content management portal 34 stores the created and approved content in the message content database 56, which may then be accessed by the health management engine 24 for distribution to the patients 12, e.g. by email, text message, through the patient portal 32 etc.

In addition to creating content, the content management portal 34 can be used to track and report the effectiveness of different message content. The effectiveness of the content is important in ensuring that the actual message is both relevant and inviting to the patient 12 so as to keep the patient 12 engaged in the program. Tracking and reporting information about content supports: the measurement of success of the portals and message delivery, captures the acquisition of patient feedback on message content, the management of content constraints, modifying the usage of time periods, deriving message frequency, determining the relationship between content and a patient's choice to opt-out, and message captions.

The report centre 46 is responsible for capturing the various inputs, outputs, activities, results, etc. that occur across the system 10. The report centre 46 can utilize both internal and external resources across the system 10 to consolidate data, package data and forward it to the relevant party for further analysis.

The report centre 46 can be utilized to track and produce reports on the pharmacist portal's website activity, which helps to understand the pharmacist's interaction with the system 10 and to be able to provide risk management actions to refine the pharmacist's experience to keep them engaged. As discussed above, the pharmacist 16 is engaged to recruit the patient 12 and thus tracking pharmacist 16 portal activity can assist in the understanding of what delivers the most value to the pharmacist 16. Examples of the tracking details that can be utilized includes without limitation: sign up rate, click thru to educational materials, click thru to advertising with the goal of adherence and patient care, time spent on site, frequency of visits and how many and which pharmacists 16 participate in the system 10, to derive insights into variations by disease condition and clusters.

Reports can also be produced and distributed periodically that detail message activity. This provides insight and understanding into the patient's interaction with messages. For example, weekly reports may allow time for review and adjustment of program messaging on an ongoing basis. Such reports can help to ensure that message and portal content are both relevant and inviting to the patient 12. Related to the delivery of messages, certain metrics can be tracked, such as cell phone number errors, sent messages (deliverable rates), received messages, etc.

Similarly, the report centre 46 enables the tracking and reporting of pharmacy activity, including new and renewal script data and drug changes. This can provide the pharmacist 16 with additional information that can benefit their customer service delivery. Also, being able to track both new and renewal script data is important to understand where adherence information appears to be working. The system 10 can also, in this way, attempt to understand the relationship between the patient's health attitudes and drop off rates, what constitutes effective medication usage, and impact on healthcare utilization. Periodic reporting also allows time for review and adjustment of the patient's program on an ongoing basis.

The use of reporting also provides information related to the patient's experience by providing insight and understanding of the patient's satisfaction and interaction with the system 10. Similarly, the patients 12 that are creating/updating profiles and maintenance regimes can be identified, which provides a link back to quality of patient engagement. Moreover, tracking the patient portal 32 activity can help to identify active versus inactive patients 12.

Various metrics can be tracked by the system 10 through the report centre 46. The following metrics may be used to determine the effectiveness of the system 10 on an ongoing basis: sign up rate, opt in/out, click thru rates (to education, advertising . . . ), which clicks are being used, origin of referral (e.g. word of mouth, peer support etc.), time spent on website, frequency of web-visits, referrals to friends, patient 12 drug history, number of patients 12 per identified disease condition, number of patients 12 that receive information materials (e.g. in person, by phone, email, mail), number of patients 12 that complete the questionnaire—others % of completion, number of patients 12 that opt-out at confirmation/welcome, number of patients 12 enrolled in the system 10, number of patients 12 that update their profile—drug class, brand, preferences, number of patients 12 that update their schedule—frequency, timing, on-hold, stop/start, number of patients 12 that attrite at various intervals (e.g. before 1st reminder, first 2 weeks, first month, 3 months, 6 months), number of patients 12 identified for re-activation, number of reactivation communications sent per patient 12, number of patients 12 that re-enroll, number of active patients 12 at the end of year 1, number of consumer care contacts per patient (e.g. by cell (text), by cell (voice msg), by cell (live voice), by email, by mail), number of contact touch points per patient 12 over a period such as twelve (12) months, number of non-reminder messages per patient 12, number of re-activation messages sent to patient 12, average number of reminders to be sent each day, capturing of recruiting pharmacy—traceability back to the pharmacist 16 will provide value when measuring pharmacist engagement, pharmacy transfers, other patient history.

Reporting thus helps to determine if the patients 12 are engaged, reading their messages, responding and interacting, which then indicates the effectiveness of the system 10 and its content.

The health management engine 24, as noted above, is active in bringing together patient cluster codes, applicable message content, and delivery methods according to a patient's self reported regimen and preferences. The health management engine 24 is also used to update the system database 58 according to changes in patient and pharmacist information. Since new patients 12 may be added on an ongoing basis, the health management engine 24 should be configured to be able to immediately send content to the patient 12, once enrolment is complete and an appropriate cluster code assigned.

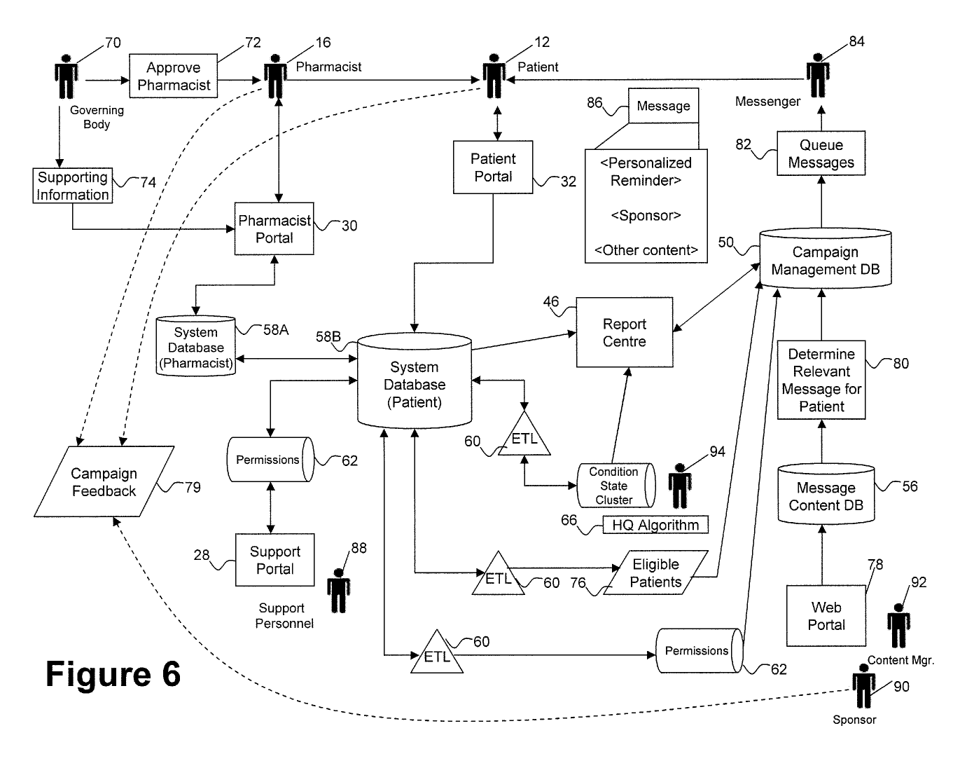

FIG. 6 illustrates various interactions between the system 10 and individuals who utilize and/or support the system 10. The system 10 is particularly suitable to partner with a governing body 70 for the pharmacists 16 in order to have a sense of trust; have access to the pharmacists 16; receive/give ongoing support; have the ability to expand on a theme, issue or problem; for scalability etc. The governing body 70 may be any regional or national organization that governs the activities of the pharmacist 16, e.g. the American Pharmacists Association (APhA). The governing body 70 may then be tasked with approving the phaunacist 16 for participation in the system 10 at 72 and provide supporting information at 74 to the pharmacist 16 through the pharmacist portal 30. The pharmacist 16, once approved, may then begin engaging patients 12, who are then directed to enrol through the patient portal 32. As can be seen in FIG. 3, the patient portal 32 and pharmacist portal 30 utilize the system database 58 for storing and retrieving data, which is shown as two separate components, namely a phaimacist portion 58A and a patient portion 58B.

In order to initiate the patient 12 into the system 10, the support portal 28 is used by support personnel 88 to make changes to the permissions 62 on an ongoing basis. The HQ algorithm system 66 is also used, either automatically, or through the input of HQ cluster personnel 94, to generate and assign a cluster code to the patient 12, which determines the type of content to be sent to that patient 12. The ETL function 60 is used to extract data from the patient portion 58B of the system database 58, e.g. for eligible patients 76.

Through a web portal 78, a content manager 92 and a sponsor 90 can create and load message content into the message content database 55, from which relevant messages can be determined for the patient 12. The campaign management database 50 then queues messages at 82 for a messenger 84 to send scheduled messages 86 to the patient 12. It can be seen that the various entities shown in FIG. 3 interact with the system 10 to create a program tailored to the patient, choose appropriate content based on a cluster designation for the patient 12 and send appropriate messages 86 at appropriate times.

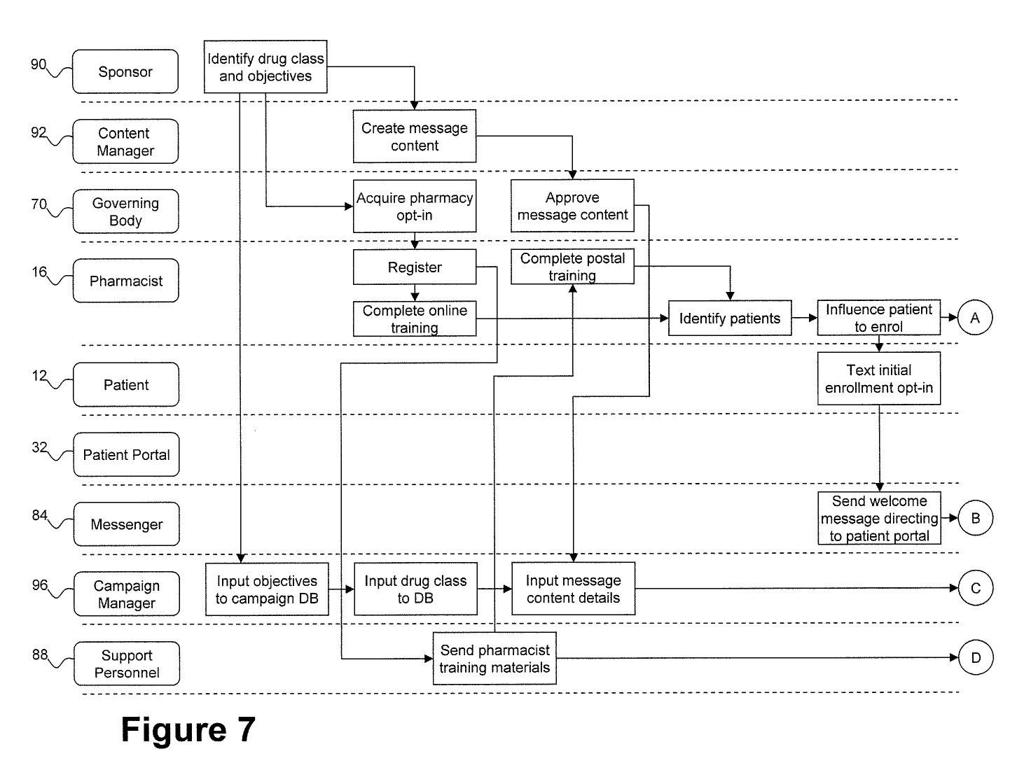

FIGS. 7 to 9 illustrate an example flow of data and series of operations performed by the entities and components shown in FIGS. 5 and 6. Beginning at FIG. 7, the system identifies to the sponsor 90, drug classes and objectives for a campaign and approaches them to offer the sponsor 90 information regarding the use and adherence associated with one of their drugs. In this way, the system 10 can maintain trust with the sponsors 90 and give them access to valuable information acquired through the health management programs being implemented and the access to the patients 12 and pharmacists 16. According to the drug class and objectives, the content manager 92 may then create message content that is suitable for achieving the objectives; the governing body 70 may then identify suitable pharmacists 16 and acquire opt-ins for those pharmacists; and the campaign manager 96 may then input the objectives and the drug class to the campaign management database 50.

Once an opt-in is acquired from the pharmacist 16, they are requested to register and complete online training, postal training (if appropriate) and identify patients. Concurrently, the governing body 70 may be contacted to approve message content created by the content manager 92, which then can be sent and input to the message content database 56 by the campaign manager 96. Also, upon registering a pharmacist 16, the support personnel 88 would, if appropriate, send the above-mentioned training materials received by post. The pharmacist 16 would then influence the patient to enrol. The patient 12 can enrol in various ways, e.g. by accessing the patient portal 32 or other website and setting up an account, which triggers an initial enrolment opt-in via text message or other means. Alternatively, the pharmacist 16 can arrange to have an introductory text message sent to begin the process, wherein the patient 12 opts in/opts out by responding to the text message. Upon opting-in, the messenger 84 then sends a welcome message directing the patient 12 to the patient portal 32.

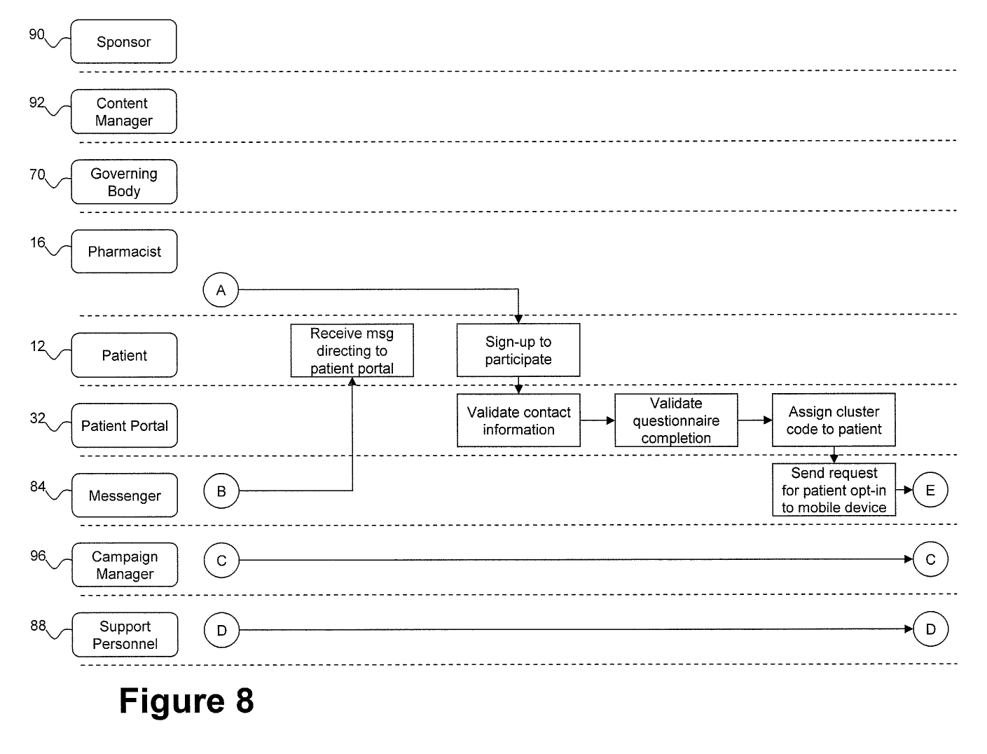

Turning now to FIG. 8, the patient receives the message directing them to the patient portal 32 and would then, if they are still interested, sign-up to participate in the program. It can be seen that further influence of the pharmacist 16 can be utilized in assisting the patient 12 in signing-up. The patient portal 32 then validates the contact information gathered through the enrolment procedure, e.g. through a confirmatory text message; and validates the questionnaire completed by the patient 12. Using the results of the questionnaire and the information provided by the patient 12, the patient portal 32 inputs such information into the HQ algorithm system 66 which assigns a cluster code to the patient 12, which uses a behavioural targeting algorithm to cluster patients 12. The cluster code would then be stored in database 64 as discussed above. The messenger 84 may then be used to send a request to the patient 12, using a selected medium (e.g. text message), for opting-in to receiving messages on their mobile device.

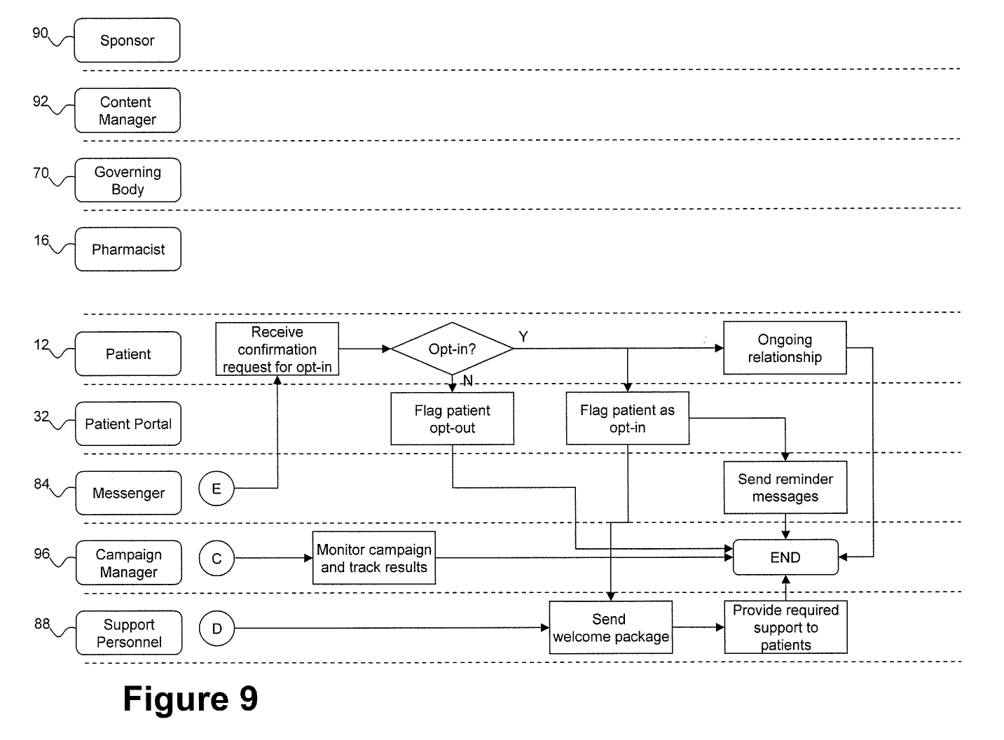

Turning now to FIG. 9, the patient 12 then receives the request to opt-in and makes a decision. If the patient 12 opts-out, the patient 12 is flagged as an opt-out and the program is not initiated. If the patient 12 opts-in, the patient 12 is flagged as an opt-in and a welcome package is sent by the support personnel 88 and reminder messages may then be sent by the messenger 84. An ongoing relationship between the patient 12 and the system is also thereby established as can be seen in FIG. 9. The campaign manager 96, during the course of the health management program, monitors the campaign and tracks the results on an ongoing basis. The support personnel 88 also provides the required support to the patients 12 on an ongoing basis.

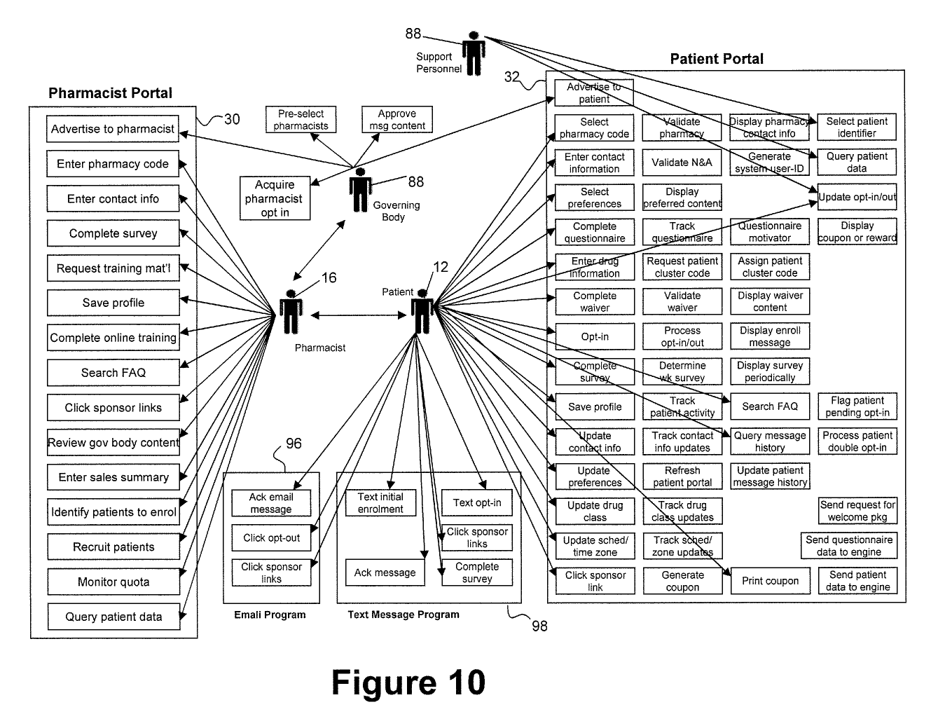

Further detail of the inputs and outputs handled by the various components of the system 10 is shown in FIGS. 10 to 12. Each box shown within each component represents a functional module such as a set of computer readable instructions stored or carried by a computer readable medium for getting or obtaining data, sending or providing data, enabling the entry of data, determining or computing or finding data, displaying data in a user interface, or instructing a computing device or other component in the operation of a function. It will be appreciated that the functional modules shown in FIGS. 10 to 12 are for illustrative purposes only and various other functions can be implemented by way of software, hardware or a combination thereof according to a particular application or embodiment.

Turning first to FIG. 10, it can be seen that each component is responsible for performing various functions and operations for corresponding entities. The pharmacist portal 30 enables the governing body 88 to advertise or otherwise post information for the pharmacist 16. The pharmacist portal 30 also facilitates the entry of information and extraction/display of information for the pharmacist 16, e.g. entry of a pharmacist code, entry of contact information, completion of a survey, requesting training material, saving a profile, completing online training, searching through frequently asked questions (FAQs), selecting (clicking thru) sponsor links, reviewing contents posted by the governing body 88, entering sales summary data, identifying patients to enrol, recruiting patients (e.g. by sending emails), monitoring quota during a trial or campaign, and querying patient data.

In addition to posting or advertising information for the pharmacist 16 through the pharmacist portal 30, the governing body 88 performs various other operations, such as acquiring a pharmacist's opt-in (e.g. in person, mail, text, email etc.), selecting pharmacists 16 for participation in a campaign and approving message content.

It can also be seen in FIG. 10 that the patient 12 is involved in many operations performed by the system 10 as they are the focus of the health monitoring program. The patient 12 interacts with an email program 96 (web-based or mobile-based) to acknowledge email messages (e.g. for opting-in), choosing to opt-out and for clicking through to sponsor links. The patient 12 also interacts with a text message program 98 provided by a mobile device for sending text messages for the initial enrolment, acknowledging messages (i.e. responding), text messaging an opt-in selection, clicking through to sponsor links and for completing surveys. The patient 12 also interacts with the patient portal 32 in various capacities to provide and gather information. Similar to the pharmacist portal 30, advertisements or other information may be posted to the patient portal 32 by the governing body 88, e.g. educational materials, facts, data etc. regarding the patient's condition. The patient 12 provides various inputs to the patient portal 32, such as for selecting a pharmacy code to identify the influencing pharmacist 16 or pharmacy, entering contact information, selecting preferences, updating opt-in/out selections, completing questionnaires, entering drug information, completing waivers, opting-in to the program, completing surveys, saving profile information, updating contact information, updating preferences, updating drug class information, updating schedule information and/or time zone information, clicking through to sponsor links, searching through FAQs, querying their message history (e.g. saved in website) and for printing coupons associated with a pharmacy, drug or other promotional items.

The patient portal 32 also performs various operations internally, as exemplified in FIG. 7. Such operations include validating a pharmacy, validating a name and address (N&A), displaying preferred content to the patient 12, tracking a questionnaire (e.g. % complete), requesting patient cluster codes, validating waivers, processing opt-in/out selections, determining a weekly survey, tracking patient activity, tracking contact information updates, refreshing the patient portal 32 user interface, tracking changes to schedule and time zone parameters, generating coupons for promotional items, generating system user-IDs, running a questionnaire incentive, assigning patient cluster codes, displaying waiver content to the patient 12, displaying enrolment messages to the patient 12, displaying a survey periodically (e.g. weekly), updating a patient's message history, displaying coupons or rewards, flagging a pending patient opt-in, processing a patient double opt-in (e.g. second indication of agreement to join program), sending a request for a welcome package for a newly enrolled patient 12, sending questionnaire data to the health management engine 24 and sending patient data to the health management engine 24. Support personnel 88 may also interact with the patient portal 32, for example to select a patient identifier, query patient data and update the opt-in/out selections in order to monitor and refine data and perform quality assurance.

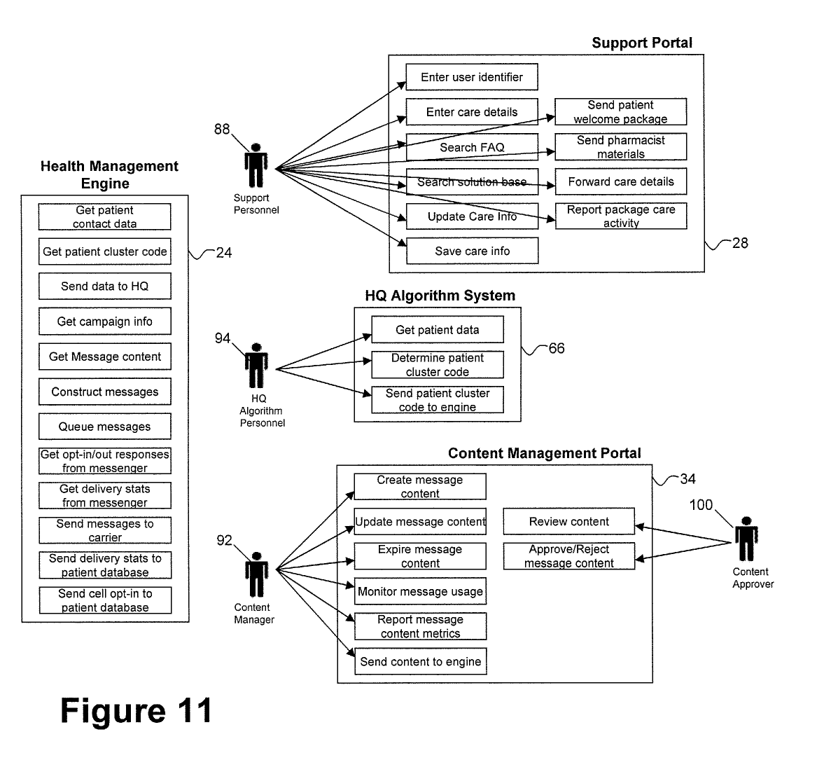

FIG. 11 illustrates various functional operations facilitated by the health management engine 24, the support portal 28, the HQ algorithm system 66 and the content management portal 34. It can be seen that the health management engine 24 operates behind the scenes and in this embodiment is not directly interacting with any of the entities outside of the system. The health management engine 24 performs operations such as getting patient contact data, getting patient cluster codes, sending data to the HQ algorithm system 66, getting campaign information, getting message content, constructing messages, queuing messages to be sent to a patient 12, getting opt-in/out responses from the messenger 84, getting delivery statistics from the messenger 84, sending messages 86 to the telecom-carrier who provides the messages 86 to the patient 12, sending delivery statistics to the patient database 58B and sending mobile (e.g. cell) opt-in selections to the patient database 58B.

The support portal 28 provides an interface for the support personnel 88 and perfoims various functions. Such functions may include enabling entry of a user identifier, enabling entry of care details, performing a search or enabling browsing of the FAQs, searching a solution library of case studies etc., updating care information, saving care information (program management), sending patient welcome packages, sending pharmacist materials, forwarding care details and reporting package care activities.

The HQ algorithm system 66, as noted above, uses various inputs to assign patients 12 into disease clusters. The HQ algorithm system 66 may operate automatically or may interact with and receive instructions and data from HQ algorithm personnel 94. The HQ algorithm system 66 operates to obtain patient data, determine patient cluster codes and send patient cluster codes to the health management engine 24.

As discussed above, the content management portal 34 obtains input from both the content manager 92 and a content approver 100. The content management portal 34 provides for the content manager 92, the ability to create message content, update message content, expire message content (i.e. decommission), monitor message usage, report message content metrics and send content to the health management engine 24. The content management portal 34 provides for the content approver 100, the ability to review message content and approve/reject message content.

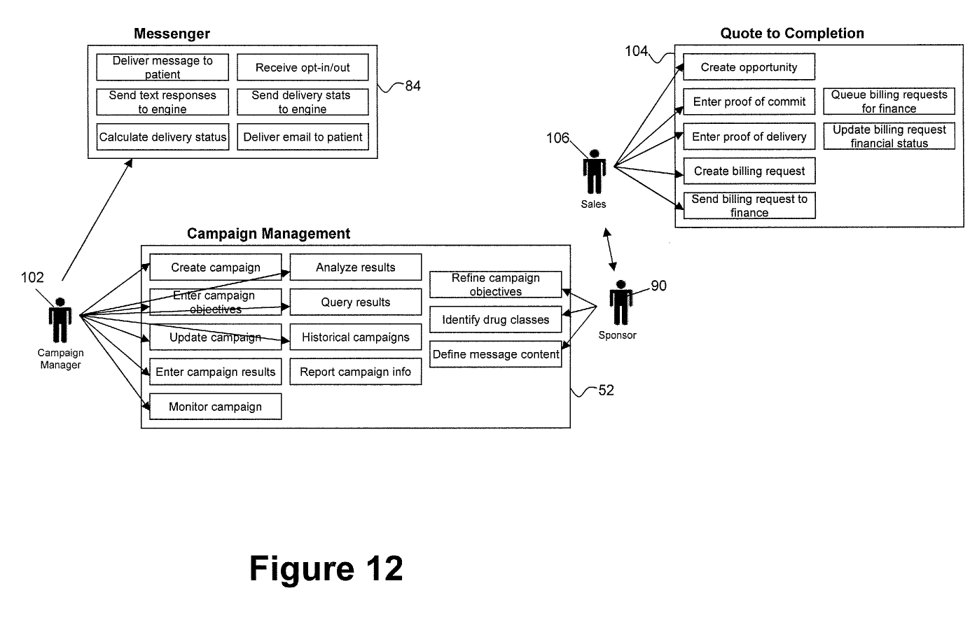

FIG. 12 illustrates various functions performed by the messenger 84, the campaign management module 52 and a quote to completion module 104. The messenger 84, which can be a service or an individual, enables the delivery of messages 86 to patients 12, sends text responses to the health management engine 24, calculates delivery status information, receives opt-in/out selections (e.g. through responses to messages 86), sends delivery statistics to the health management engine 24 and delivers emails to patients 12.

The campaign management module 52 provides an interface for the campaign manager 102. The campaign management module 52 provides for the campaign manager 102, the ability to create a campaign, enter campaign objectives, update a campaign, enter campaign results, monitor a campaign, analyze results, query results and view historical campaigns. The campaign management module 52 is also responsible for reporting campaign information to the report centre 46. The campaign management module 52 provides for the sponsor 90, the ability to refine campaign objectives, identify drug classes and define message content. The campaign manager 102 may also be given access to the messenger 84 for managing messaging parameters.

The quote to completion module 104 can be used to provide an interface for sales personnel 106 to look at future opportunities to approach sponsors 90, e.g. for off-patent drugs etc. and guide the sponsors 90 to the system 10 to take advantage of the benefits discussed herein. The sales personnel 106 can also enter proof of commitment, enter proof of delivery, create a billing request, send billing request to finance. The quote to completion module 104 also queues billing requests for finance and updates billing request financial data.

It can seen from the above that the system 10 engages the patient 12 through the influence of the pharmacist 16. Continued adherence and utilization of the system 10 then is affected by the content which is presented to the patient 12. As discussed above, in addition to harnessing the patient-pharmacist relationship, the system 10 utilizes behaviour targeting to differentiate between patients 12, deliver more personalized content and thus improve adherence.

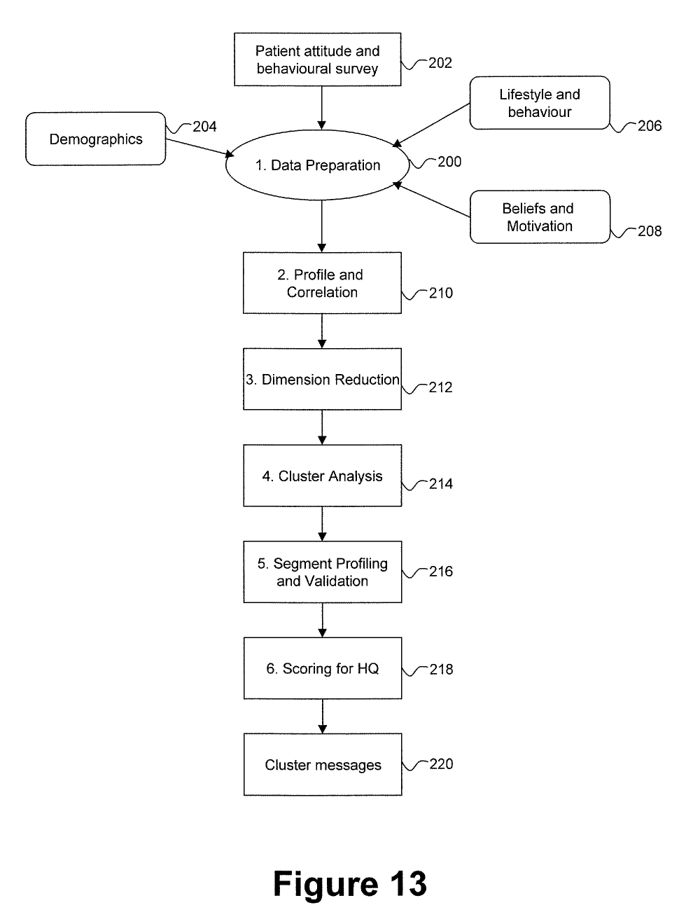

Turning now to FIG. 13, one example of a segmentation process is shown. Stage 1 at 200 involves data preparation, which considers the following data components: patient attitudes and behavioural survey information 202, demographic and geographic data 204, lifestyle and behaviour related to healthcare 206 and beliefs and motivations 208. As discussed aboye, a patient's attitudes and behaviour data 202 can be derived from surveys conducted using the patient portal 32 or other website, call centre etc. provided by the system 10.

The data sources typically include different scales of data, e.g. nominal, ordinal and interval scales. To deal with this, a unified scale and format can be used to fill in missing values and cleanse the data of outliers and errors. Furthermore, for each condition, the available information can be identified to derive the most relevant variables. A complete set of information may therefore be developed for each patient 12 and attached to their record stored in the patient database 58B.

Stage 2 at 210 involves profile and correlation analyses. In this stage, a patient profile analysis is performed for each condition to identify important attributes. For example, this can involve quantifying how ethnicity, occupation and income are related to the condition groups of diabetes and heart diseases. It has been found that the correlation analysis of attitude data reveals an association between a patient's healthcare attitudes and behaviours. For example, people who are not concerned about what is in the pill as long as it works may also believe that the disease is an enemy to be conquered, and would also be of the type to look for bargains and believe their job causes stress problems. In another example, people who seek a pharmacist's advice may also believe the disease is the enemy to be conquered, but may be of the type that generally prefers not to take any pills. The correlation of attitudes and behaviours can thus assist in profiling a patient 12 to determine how best to target them to promote adherence.

Stage 3 at 212 involves dimension reduction to produce a perceptual map. Correlation and factor analysis can be used to reduce the co-linearity among the variables and the dimension of the dataset. For example, Principal Component Analysis (PCA) can be applied to simplify the description of a set of interrelated variables in a data matrix. PCA transforms the original variables into new uncorrelated variables, commonly referred to as principal components (PC). Each principal component is a linear combination of the original variables:

Y=w₂X₁+w₂X₂+w₃X₃+ . . . +wₙXₙ;

where wᵢ represents a weight, Xᵢ represents the variables and Y is the weighted sum of Xᵢ linear combinations.

Although other methods can be employed in stage 3, PCs typically have several advantages:
There are the same number of PCs as the dimension of the database used;
The PCs are mutually orthogonal;
The first PC has the largest variance;
The second PC is orthogonal to the first PC and has the largest variance among the remaining PCs; and

The third PC is orthogonal to the previous two and has the largest variance among the remaining PCs and so on.

Since information in a dataset is described by the variance of the data, the data can be standardized so that the total variance is equal to the number of variables and equal to the sum of all eigenvalues of the correlation matrix. The PCs that represent most information of the dataset can be selected and the irrelevant variables eliminated. This leads to a reduced dataset with concise information for better cluster analyses.

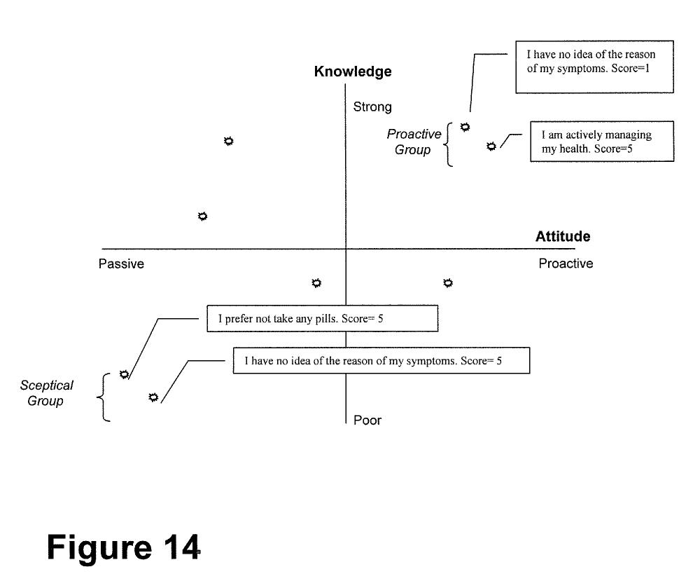

A correspondence analysis is a descriptive/exploratory technique designed to analyze frequency cross-tabulation tables which contain some measure of correspondence between the rows and columns. In a correspondence analysis model, a modified Euclidean distance named Distribution Distance (or Chi-square distance) is used to measure the row centre, column centre and table centre. Based on the coordinates that correspondence analysis provides, a perceptual map can be derived to visually display the perceptions of different patients and clustering patient groups. FIG. 14 provides a sample two dimensional perceptual map resulting from a correspondence analysis. From this map, proactive and sceptical groups can be identified based on where they lie in the graph.

Stage 4 at 214 involves a cluster analysis. Various cluster techniques can be employed at this stage, including hierarchical clustering, K-Means method, projected clusters, feature selections, fuzzy clusters and neural networks.

To illustrate one example, the K-Means method will be provided. The K-Means method includes a initiation stage followed by an iteration stage. The initiation stage comprises selecting K points as initial seeds and assigning each database record to the closest see and foini K clusters. The iteration stage comprises calculating the centroid of each cluster, assigning each database record to the closest centroid to form new clusters and if the convergence criteria are satisfied, stop, otherwise, repeat the iteration steps. It has been found that K-Means methods are particularly effective for large databases.

The following provides an adaptive K-Means method that iteratively selects the seeds and identifies the optimal number of clusters. For example, the number of clusters can be determined by locally maximizing a cubic clustering criterion and local pseudo F-statistics and locally minimizing the pseudo t² statistics:

$${t}^{2} = \frac{{N}_{k} {N}_{l} ‖ {\overline{x}}_{k} - {\overline{x}}_{l} ‖}{( {\sum }_{i ∈ {C}_{k}} ‖ {\overline{x}}_{i} - {\overline{x}}_{k} ‖ + ‖ {\overline{x}}_{i} - {\overline{x}}_{l} ‖ ) ( {N}_{k} + {N}_{l} )}$$

The sizes of the clusters can also be considered to justify the target communications. the respondents can be split into two parts, one for cluster analysis and another for validation.

Stage 5 at 216 involves segmentation profiling and validation, namely profiling the segments to validate differences between clusters. For example, the distinct profiles of clusters A and F defined above indicate that such clusters would clearly differentiate between different types of patients and, as such, the clusters would be deemed to be correct. The following is an example profile for clusters A and F:

| Cluster Name | Profile |
|---|---|
| A: Sceptical | Don't trust physicians |
| | View medications negatively |
| | Very concerned about long-term health risks |
| | Don't think high blood pressure is very serious |
| F: Proactive | Very active in managing their health |
| | Think medications are critical in controlling |
| | high blood pressure |
| | Have excellent relationship with physician |

In addition, the R-square can be calculated according to the following operations:

$$1 ) {R}^{2} = 1 - \frac{{\sum }_{k} {\sum }_{i ∈ {C}_{k}} ‖ {x}_{i} - {\overline{x}}_{k} ‖}{{\sum }_{i = 1}^{n} ‖ {x}_{i} - \overline{x} ‖}$$

can be computed to estimate how much information is described by the clusters for verification.

2) Variance within a cluster is typically small and variance between clusters should be large. The ratio of between-cluster-variance to within-cluster-variance

$$\frac{{R}^{2}}{1 - {R}^{2}}$$

and the pseudo F-statistics can be used to measure quality of the clusters:

$$\frac{\frac{{R}^{2}}{( c - 1 )}}{\frac{( 1 - {R}^{2} )}{( n - c )}}$$

3) A T-test can then be run against the centroids of clusters to verify the significance of their differences.

Stage 6 at 218 involves the HQ scoring, which is performed using an HQ scoring function, run by the HQ algorithm system 66 to assign each new patient to the most appropriate cluster. There are various ways to implement the HQ scoring function, such as using regression analysis at the cluster level, applying discriminant functions at the cluster level or applying a statistical distance function to the centroids of the clusters. The inputs to the implemented function would be the responses given by the patients 12 to the survey or any other inputs they provide. The output from stage 6 is a score assigning the patient to a cluster.

Using the score, the system 10 may then utilize cluster-appropriate messages at 220 for providing reminders, educational information etc. as discussed above.

To enhance for the patient 12, their motivation for adherence and ultimately the overall experience of using the system 10, the system 10 can be configured to track usage by the patient 12 and award points or other incentives that can be redeemed for other products or services. For example, travel rewards could be accumulated through continued use of the system 10 and adherence to a health management regimen.

It can therefore be seen that the above-described system 10 provides an integrated communications platform that provides a pharmacist 16 (or other medical professional) assisted medication therapy management program involving a behavioural targeting algorithm to personalize mobile messages 86 designed to increase medication adherence and to improve health outcomes among patients 12 living with chronic disease.

The integrated communications platform provides a mobile messaging platform that sends scheduled reminders to persons living with such chronic diseases to take their medication. The reminders may be delivered to the patients 12 via any mobile messaging medium, e.g. text messages, email etc. In this way, the messages 86 can be received anywhere and at any time to improve the link between the patient and the system. The reminders can be presented in a personalized information message that is specific to a particular disease and may include tips to promote adherence and self-management. The supporting communications platform may include a personalized web page for each patient 12 that includes a compendium of messages along with more detailed information and peer support for their disease. As noted above, a behavioural targeting algorithm is used to identify segments of patients according to their health beliefs and attitudes. The algorithm uses scientific measurement tools to segment beliefs by disease type and stage. It has been found that the distribution of the system through medical professionals such as pharmacists can provide a unique point of customer contact and allow pharmacists to engage patients and improve medication adherence and overall health.

It will be appreciated that the system 10 and underlying principles described above may also be applied to other applications and need not be limited to chronic illnesses and drug regimens. For example, the system 10 can be employed in other fields of health care such as wellness, fitness, cosmeceuticals, smoking cessation, weight loss, over the counter medications etc. In each variation, the system 10 would be adapted to provide a communication link between the user or individual (e.g. patient) and an authoritative and trustworthy entity while applying similar behavioural targeting to provide more personalized and behaviour changing content to the user. Similarly, the system 10 can be adapted for non-health applications such as product promotion, business development, and educational uses such as curriculum support, campus security and testing (e.g. SATs). As such, it can be seen that the principles described herein are equally applicable to many applications of promoting adherence to wellness and need not be limited to chronic illnesses as exemplified herein.

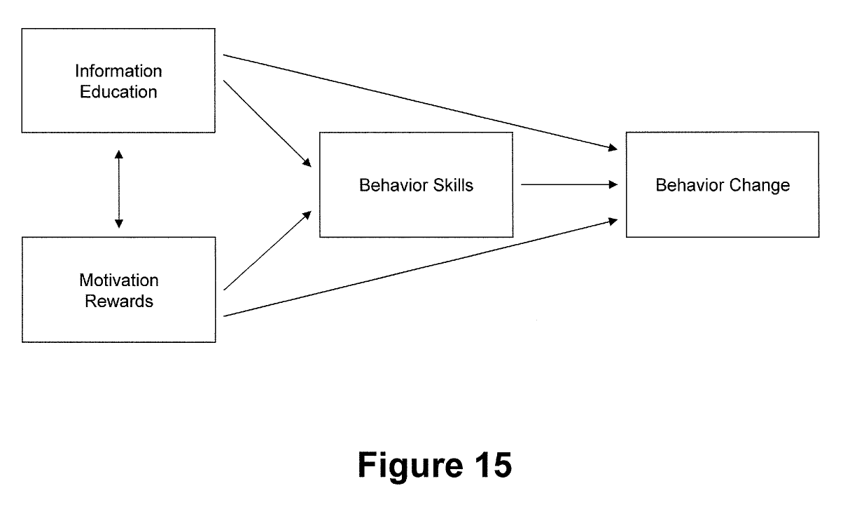

For example, the above principles can be generalized as shown in FIG. 15. In general, the system 10 provides a framework that combines awareness, education and motivation to develop behaviour skills, which in turn can result in behaviour change. This can be applied to any “wellness” management program as noted above. The framework enables the delivery of timely and relevant information, i.e. personally valued information delivered by credible sources. As will be discussed further below, themed content can be developed with a building block approach or “shaping increments”. The framework can also provide personalized and versatile, easy to use tools. Readily available, easy to use resources help users translate information into meaningful action and that guide intelligent wellness decision-making. These tools can empower the user to make decisions that are right for them. This can be achieved, as exemplified above, by linking mobile messaging with a web platform and a link to a wellness professional or other credible source (e.g. pharmacist). Access to the content is enhanced using multiple interactive communications channels. This provides low cost, convenient opportunities to interact with the wellness professional and peers in order to interpret information, consult on behaviour change, and monitor progress. Furthermore, periodic rewards for ongoing participation, e.g. coupons, contests, sponsored program rewards, “after the click” values, etc.

The content delivered to the user is tailored to apply cognitive behavioural learning principles. Such tailoring intends to engage and empower, become a desired part of the user's active/mobile lifestyle, deliver a personalized tailored message in real-time, motivate and reinforce with relevant content and rewards, “shaping” timely increments of knowledge and skill support to health education and forgetfulness.

The cognitive-behavioural techniques can be applied to add value and familiarity. Each shaping increment can be numbered to indicate a link to the particular program, and can be used to develop or “build” on a central learning theme. By building on increments of content, the user can build their own base of knowledge and gradually become more informed on relevant issues.

The web-based platform provides another access point to the system 10 and allows the user to personalize their own page and environment. The web environment is built to provide preventative education, risk factor reduction, promote self-care, management of a condition, and adherence to a program to improve wellness. The web platform builds on the mobile messages to enable the user to have access to archived messages and content using drill down links or other user interface techniques. The web platform also provides a portal for the user to “pull” down content on a specific basis. The system 10 can store content for many users and thus provide access to a library of knowledge, that is built up over time.

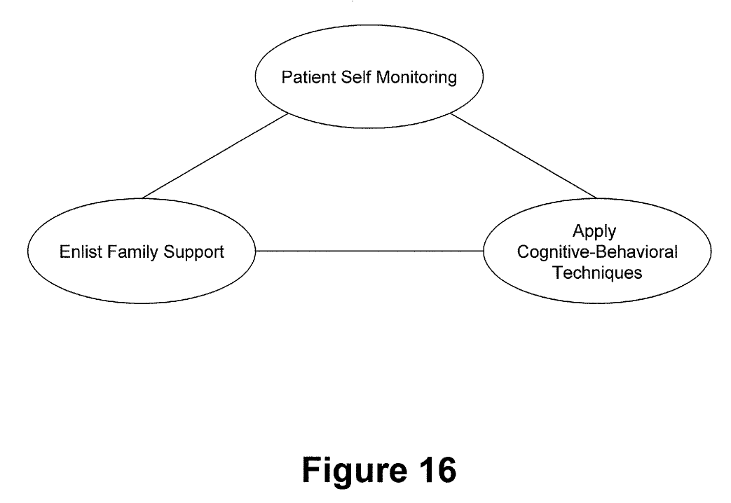

It has also been recognized that the system 10 can be extended to incorporate the participation of support networks for the user, in particular for patients in a health management system 10. For example, it has been found that effective interventions involve asking participants to monitor their own medication habits, applying cognitive behavioural techniques to target problematic beliefs, and enlisting family support (Cook, P. F.; “Pyschosocial interventions to improve medication compliance: A meta-analysis”; 1999). Therefore, the support structure can enlist family support to complement the cognitive behavioural techniques and the patient 12 self-monitoring provided by the system 10, as shown in FIG. 16. A companion support program (not shown) can be deployed to engage and empower both the patient 12 and their designated caregiver/friend/family etc. The incorporation of the caregiver allows the system 10 to leverage off of the personal contact and motivation that can be provided by those closest to the patient 12.

Although the invention has been described with reference to certain specific embodiments, various modifications thereof will be apparent to those skilled in the art without departing from the spirit and scope of the invention as outlined in the claims appended hereto.

1. A method for providing a wellness management program for a user comprising:
obtaining information pertaining to said user, said information providing an indication of behaviours, attitudes and demographic data for said user;
associating a wellness professional with said user;
assigning said user to one of a plurality of clusters, each cluster defining a user group with similar behaviours and attitudes toward said wellness management program;
obtaining content according to said one cluster assigned to said user, said content being related to said wellness management program;
sending messages to said user using said content according to a schedule; and
enabling a communication link between said user and said wellness professional.

2. The method according to claim 1 wherein said user is a patient, said wellness professional is a pharmacist, and said wellness management program pertains to said patient's health.

3. The method according to claim 2 comprising providing additional information to said patient through a patient portal configured to be accessible to said patient.

4. The method according to claim 3 comprising providing said communication link using a pharmacist portal accessible to said pharmacist and enabling communication between said pharmacist portal and said patient portal and vice versa.

5. The method according to claim 2 comprising establishing a campaign identifying parameters of said health management program, said campaign being initiated by a campaign manager.

6. The method according to claim 2 comprising incorporating sponsorship content into said messages to compensate for the processing and delivery of said messages.

7. The method according to claim 2 comprising providing a support portal to enable assistance to be requested by said patient and said pharmacist.

8. The method according to claim 2 comprising monitoring data associated with participation of said patients and said pharmacists in said health monitoring program and providing said data to a report centre.

9. The method according to claim 2 comprising generating said plurality of clusters using a behavioural segmentation of information pertaining to a plurality of patients and assigning said plurality of clusters according to said segmentation.

10. The method according to claim 2 comprising obtaining said information pertaining to said patient using a survey provided to said patient, said survey designed to obtain said indication of behaviours, attitudes and demographic data.

11. The method according to claim 1 comprising obtaining an identification from said patient of a referring pharmacist for associating said pharmacist; and obtaining feedback from said referring pharmacist regarding adherence of said patient to said health management program.

12. The method according to claim 2 wherein said health management program comprises a drug regimen.

13. The method according to claim 12 wherein said messages comprise medication reminders sent according to said drug regimen.

14. The method according to claim 1 further comprising tracking adherence to said wellness management program and accumulating rewards for said user accordingly.

15. A computer readable medium comprising computer executable instructions for causing a computing device to perform the method according to claim 2.

16. A health management system for providing a wellness management program for a user comprising:
a first interface for obtaining information pertaining to said user, said information providing an indication of behaviours, attitudes and demographic data for said user;
a management engine for associating a wellness professional with said user, for assigning said user to one of a plurality of clusters, each cluster defining a user group with similar behaviours and attitudes toward said wellness management program, for obtaining content according to said one cluster assigned to said user, said content being related to said wellness management program;
a second interface to a communications service for sending messages to said user using said content according to a schedule; and
a communication link between said user and said wellness professional.

17. The system according to claim 16 wherein said user is a patient, said wellness professional is a pharmacist, and said wellness management program pertains to said patient's health.

18. The system according to claim 17 wherein said first interface is a patient portal providing access to said system for said patient, said patient portal being configured to be accessible to said patient.

19. The system according to claim 18 comprising a pharmacist portal accessible to said pharmacist for providing said communication link, said patient portal and said pharmacist portal being configured to enable communication between one another.

20. The system according to claim 17 comprising a campaign management module for establishing a campaign identifying parameters of said health management program, said campaign being initiated by a campaign manager using said campaign management module.

21. The system according to claim 17 wherein said health management engine is configured for incorporating sponsorship content into said messages to compensate for the processing and delivery of said messages.

22. The system according to claim 17 comprising a support portal to enable assistance to be requested by said patient and said pharmacist.

23. The system according to claim 17 comprising a report service for monitoring data associated with participation of said patients and said pharmacists in said health monitoring program and for providing said data to a report centre.

24. The system according to claim 17 comprising an algorithm for generating said plurality of clusters using a behavioural segmentation of information pertaining to a plurality of patients and assigning said plurality of clusters according to said segmentation.

25. The system according to claim 16 wherein said first interface is configured to obtain said information pertaining to said patient using a survey provided to said patient, said survey designed to obtain said indication of behaviours, attitudes and demographic data.

26. The system according to claim 17 wherein said first interface is configured for obtaining an identification from said patient of a referring pharmacist for associating said pharmacist; and said health management engine is configured for obtaining feedback from said referring pharmacist regarding adherence of said patient to said health management program.

27. The system according to claim 17 wherein said health management program comprises a drug regimen.

28. The system according to claim 27 wherein said messages comprise medication reminders sent according to said drug regimen.

29. The system according to claim 16 wherein said management engine is further configured for tracking adherence to said wellness management program and accumulating rewards for said user accordingly.

30. A method for providing a wellness management program for a user, said method comprising:
obtaining information pertaining to the user, said information providing an indication of behaviours, attitudes and demographic data for said user;
obtaining content related to said wellness management program for promoting adherence thereto;
dividing said content into a plurality of increments; and
sending messages to said user according to a schedule, each message comprising one of said increments to build a knowledge base for said user.

31. The method according to claim 30 further comprising storing said content in said plurality of increments, archiving said content, and making said content available to said user for further use thereof.

32. The method according to claim 30 further comprising tracking interactions with said increments to assign rewards to said user.
